(19) United States
(12) Patent Application Publication
(10) Pub. No.: US 2021/0304079 A1
(43) Pub. Date: Sep. 30, 2021

(54) SERVICE PROVISION SYSTEM, CONTROL DEVICE, AND MATCHING METHOD

(71) Applicant: HONDA MOTOR CO., LTD., Tokyo (JP)

(72) Inventors: Haruka TOMO, Tokyo (JP); Erina AOKI, Tokyo (JP); Kaori KANEKO, Tokyo (JP)

(73) Assignee: HONDA MOTOR CO., LTD., Tokyo (JP)

(21) Appl. No.: 17/188,806

(22) Filed: Mar. 1, 2021

(30) Foreign Application Priority Data
Mar. 26, 2020 (JP) 2020-056333

(51) Int. Cl. G06Q 10/02; G06Q 10/06; G06Q 30/02; G06Q 50/30

(52) U.S. Cl. CPC G06Q 10/02; G06Q 10/06312; G06Q 50/30; G06Q 30/0284; G06Q 10/06315

(57) ABSTRACT

A service provision system includes a control device which recognizes a desired boarding condition of a user based on information received from a user device, recognizes a required vehicle condition at a predetermined location for a predetermined time zone based on the desired boarding condition, recognizes a vehicle capable of picking up the user at the predetermined location in the predetermined time zone based on the required vehicle condition and information received from the driver device, adjusts a supply-demand balance based on the required vehicle condition and the vehicle capable of picking up the user. The control device specifies the user and the vehicle that are present in a predetermined region including the predetermined location at a timing before the predetermined time zone, selects an optimal vehicle for the specified user from among the specified vehicles, and outputs a selection result.

### CROSS-REFERENCE TO RELATED APPLICATIONS

This application is based upon and claims the benefit of priority from prior Japanese patent application No. 2020-056333, filed on Mar. 26, 2020, the entire contents of which are incorporated herein by reference.

### TECHNICAL FIELD

The present disclosure relates to a service provision system, a control device, and a matching method.

### BACKGROUND ART

JP-A-2004-178386 discloses a technique related to “park and ride” in which a user moves to a parking lot provided at a location slightly away from an event venue and the user goes to the event venue from the parking lot using public transportation. JP-A-2004-178386 discloses that a taxi company, which is public transportation, obtains an estimated time of arrival of the user at the parking lot to reduce waiting time of the user for a taxi in the parking lot.

The estimated time of arrival of the user and the taxi may change depending on traffic conditions and the like. For example, when the taxi that can meet a boarding request of the user is matched at a timing when the user requests boarding, the user or the taxi may wait for a long time due to a change in the estimated time of arrival of at least one of the user and the taxi.

### SUMMARY OF INVENTION

An object of the present disclosure is to improve convenience in a service in which a user who desires to board boards a vehicle and is transported to a destination.

A service provision system according to an aspect of the present disclosure is a service provision system in which a user device of a user who desires to board a vehicle at a predetermined location, a driver device of a driver who drives a vehicle that allows the user to board, and a control device are connected via a network, in which the control device is configured to execute: first processing of, based on information received from the user device, recognizing a desired boarding condition of a user owning the user device, the desired boarding condition including an estimated time zone of boarding a vehicle at the predetermined location; second processing of recognizing a required vehicle condition at the predetermined location for a predetermined time zone based on the desired boarding condition; third processing of recognizing a vehicle capable of picking up the user at the predetermined location in the predetermined time zone based on the required vehicle condition and information received from the driver device; fourth processing of adjusting, based on the required vehicle condition and the vehicle capable of picking up the user, a supply-demand balance between the user who desires to board at the predetermined location in the predetermined time zone and the vehicle capable of picking up the user; and fifth processing of, at a timing before the predetermined time zone is reached, specifying, based on position information of the user device and position information of the driver device of the driver of the vehicle capable of picking up the user, the user and the vehicle that are present in a predetermined region including the predetermined location from among the users and the vehicles capable of picking up the users that are recognized until the fourth processing, selecting an optimal vehicle for the specified user from among the specified vehicles, and outputting a selection result.

A control device according to an aspect of the present disclosure is a control device configured to match a user who desires to board a vehicle at a predetermined location with the vehicle, the control device including: a processor, in which the processor is configured to execute: first processing of, based on information received from a user device of the user, recognizing a desired boarding condition of the user including an estimated time zone of boarding a vehicle at the predetermined location; second processing of recognizing a required vehicle condition at the predetermined location for a predetermined time zone based on the desired boarding condition; third processing of recognizing a vehicle capable of picking up the user at the predetermined location in the predetermined time zone based on the required vehicle condition and information received from a driver device of a driver who drives the vehicle; fourth processing of adjusting, based on the required vehicle condition and the vehicle capable of picking up the user, a supply-demand balance between the user who desires to board at the predetermined location in the predetermined time zone and the vehicle capable of picking up the user; and fifth processing of, at a timing before the predetermined time zone is reached, specifying, based on position information of the user device and position information of the driver device of the driver of the vehicle capable of picking up the user, the user and the vehicle that are present in a predetermined region including the predetermined location from among the users and the vehicles capable of picking up the users that are recognized until the fourth processing, selecting an optimal vehicle for the specified user from among the specified vehicles, and outputting a selection result.

A control method according to an aspect of the present disclosure is a matching method that is for matching a user who desires to board a vehicle at a predetermined location with the vehicle and that is executed by a processor, the matching method including: first processing of, based on information received from a user device of the user, recognizing a desired boarding condition of the user including an estimated time zone of boarding a vehicle at the predetermined location; second processing of recognizing a required vehicle condition at the predetermined location for a predetermined time zone based on the desired boarding condition; third processing of recognizing a vehicle capable of picking up the user at the predetermined location in the predetermined time zone based on the required vehicle condition and information received from a driver device of a driver who drives the vehicle; fourth processing of adjusting, based on the required vehicle condition and the vehicle capable of picking up the user, a supply-demand balance between the user who desires to board at the predetermined location in the predetermined time zone and the vehicle capable of picking up the user; and fifth processing of, at a timing before the predetermined time zone is reached, specifying, based on position information of the user device and position information of the driver device of the driver of the vehicle capable of picking up the user, the user and the vehicle that are present in a predetermined region including the predetermined location from among the users and the vehicles capable of picking up the users that are recognized until the fourth processing, selecting an optimal vehicle for the specified user from among the specified vehicles, and outputting a selection result.

According to the present disclosure, supply and demand are adjusted by fourth processing. Therefore, even when an arrival time of a user or a vehicle that can pick up the user at a predetermined location is changed from an original schedule, it is possible to reduce waiting time of the user or the vehicle that can pick up the user, and it is possible to improve convenience in a service in which the user who desires to board boards the vehicle and is transported to a destination.

### BRIEF DESCRIPTION OF DRAWINGS

FIG. 1 is a schematic diagram showing a schematic configuration of a service provision system 100 according to an embodiment of the present disclosure;

FIG. 2 is a schematic diagram showing an example of a table stored in a database 32;

FIG. 3 is a flowchart showing operation of a processor 31;

FIG. 4 schematically shows a recognition result of the processor 31 when determination in step S7 in FIG. 3 is executed;

FIG. 5 is a schematic diagram showing processing in step S11 in FIG. 3;

FIG. 6 is a schematic diagram showing an example of a recognition state of the processor 31 when determination in step S9 in FIG. 3 is YES; and

FIG. 7 is a schematic diagram showing another example of the recognition state of the processor 31 when the determination in step S9 in FIG. 3 is YES.

### DESCRIPTION OF EMBODIMENTS

A service provision system according to an embodiment of the present disclosure provides a matching service of matching a user with a transportation vehicle. The user desires to board a vehicle so as to move from a predetermined location such as a bicycle parking lot or a parking lot to a predetermined destination such as a station or an event venue. The transportation vehicle transports the user from the above-described predetermined location to the above-described predetermined destination. After the user and the transportation vehicle are matched, the user boards the transportation vehicle, heads for the destination, pays a boarding fee, and disembarks at the destination.

The user who uses the matching service can use the service by operating a device and registering (registration of personal information including a user ID and the like) the user on a service site. A driver of the transportation vehicle who uses the matching service can use the service by operating a device and registering (registration of personal information including a driver ID, a type of the transportation vehicle, a boarding fee required for the transportation from the predetermined location to the predetermined destination, and the like) the driver on the service site. The type of the transportation vehicle is information indicating whether the vehicle is a two-wheeled vehicle such as a motorcycle, a four-wheeled vehicle such as a small vehicle or a medium-size vehicle, or a bus such as a large vehicle.

Hereinafter, a device (for example, a smartphone, a tablet terminal, or a car navigation device mounted on a user vehicle driven by the user) owned by the user who uses the matching service will be described as a user device. A device (for example, a smartphone, a tablet terminal, a car navigation device mounted on the transportation vehicle, or the like) owned by the driver of the transportation vehicle who uses the matching service will be described as a driver device.

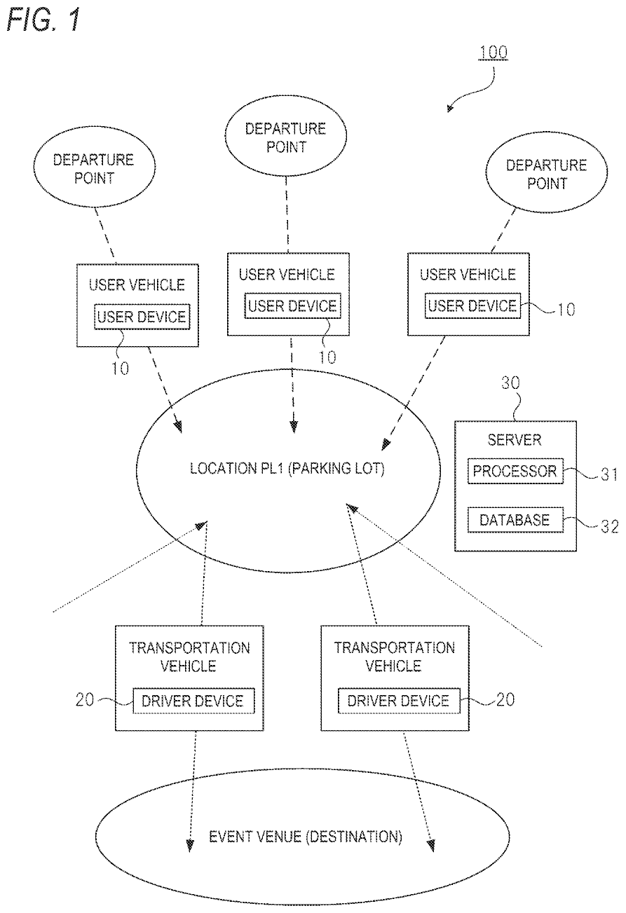

FIG. 1 is a schematic diagram showing a schematic configuration of a service provision system 100 according to an embodiment of the present disclosure. The service provision system 100 includes a server 30, a user device 10 of the user registered in the matching service, and a driver device 20 of the driver registered in the matching service. The server 30, the user device 10, and the driver device 20 can communicate with one another via a network such as the Internet (not shown).

The number of the user devices 10 is three in FIG. 1. However, the number of the user devices 10 is equal to the number of users who have executed the user registration. The number of the driver devices 20 is three in FIG. 1. However, the number of the driver devices 20 is equal to the number of drivers who have executed the driver registration. The user device 10 moves together with the user or the user vehicle on which the user boards. Therefore, a position of the user device 10 is the same as a position of the user who owns the user device 10. The driver device 20 moves together with the transportation vehicle driven by the driver. Therefore, a position of the driver device 20 is the same as a position of the transportation vehicle driven by the driver.

Each of the user device 10 and the driver device 20 is an electronic device including a display of information using a display unit, a position detection device configured to detect position information, an operation interface such as a touch panel configured to allow information to be input, a communication interface configured to allow connection to the network, and the like. The user can access the service site by the user device 10. The driver can access the service site by the driver device 20.

The server 30 includes a processor 31, a database (DB) 32 implemented by a device such as a hard disk device or a solid state drive (SSD) capable of storing information, and a random access memory (RAM) and a read only memory (ROM) (not shown). The processor 31 constitutes a control device. The ROM stores a program including a matching program.

The processor 31 is various processors configured to execute the above-described program to perform processing. Examples of the various processors include a programmable logic device (PLD) such as a central processing unit (CPU) and a field programmable gate array (FPGA), or a dedicated electric circuit such as an application specific integrated circuit (ASIC) which is a processor having a circuit configuration specially designed for executing specific processing. The programmable logic device (PLD) is a general-purpose processor configured to execute programs to execute various types of processing and is a processor whose circuit configuration can be changed after being manufactured. More specifically, structures of these various processors are electric circuits in which circuit elements such as semiconductor elements are combined. The processor 31 may be one of the various processors, or may be a combination of two or more processors of the same type or different types. The processor 31 may be a plurality of processors provided in computers distributed via the network.

The database 32 only needs to be in a location accessible from the server 30. For example, the database 32 may be built in another computer connected to the network, or may be externally attached to the server 30.

The database 32 stores, under control of the processor 31, boarding information based on boarding request information received from the user device 10 and pick-up information based on pick-up request information received from the driver device 20.

An overall flow of the matching service is as follows. First, when leaving home by a user vehicle such as a bicycle, a motorcycle, or an automobile, or while moving by the user vehicle, the user makes a boarding request to the server 30 by the user device 10, and heads for a location PL1 (the parking lot in FIG. 1) which is a relay point to the destination (the event venue in FIG. 1). In FIG. 1, the relay point is only the location PL1. However, a plurality of relay points may be present.

Specifically, the user operates the user device 10 to transmit, from the user device 10 to the server 30, the boarding request information including a desired location for boarding, an estimated time of arrival at the location, a desired condition, a desired destination, a user ID, and the like.

The estimated time of arrival included in the boarding request information may be manually input by the user, or may be derived by the user device 10 based on various types of information. Specifically, the user device 10 may predict the estimated time of arrival at the desired location for boarding input by the user based on the desired location for boarding, a position detected by a position detection device of the user device 10, and traffic condition information acquired from another server (not shown).

The desired condition includes the number of people scheduled to board, a desired type of the transportation vehicle for boarding, desired waiting time until boarding (5 minutes or less, 10 minutes or less, 20 minutes or less, or the like), a desired rank of the boarding fee for the transportation to the destination (for example, any one of three ranks), and a desired priority of each of the type, the waiting time, and the rank.

The processor 31 of the server 30 receives the boarding request information from the user device 10, accepts the boarding request, and stores boarding information in the database 32 based on the boarding request information.

The boarding request information may include position information of the user device 10 at a time point when the boarding request is made, instead of information of the above-described estimated time of arrival. In this case, the processor 31 predicts the estimated time of arrival of the user who has made the boarding request at the location based on the position information, the above-described traffic condition information, and location information included in the boarding request information. Then, the processor 31 stores a prediction result in the database 32 as the boarding information.

The driver of the transportation vehicle makes a pick-up request to the server 30 by the driver device 20, and heads for the location PL1 which is a pick-up location. Specifically, the driver operates the driver device 20 to transmit, from the driver device 20 to the server 30, pick-up request information including a desired location for pick-up, an estimated time of arrival at the location, a destination where the user can be transported, a driver ID, and the like.

The estimated time of arrival included in the pick-up request information may be manually input by the driver, or may be derived by the driver device 20 based on various types of information. Specifically, the driver device 20 may predict the estimated time of arrival at the desired location for pick-up input by the driver based on the desired location for pick-up, a position detected by a position detection device of the driver device 20, and traffic condition information acquired from another server (not shown).

The processor 31 of the server 30 receives the pick-up request information, accepts the pick-up request, and stores pick-up information in the database 32 based on the pick-up request information.

The pick-up request information may include position information of the driver device 20 at a time point when the pick-up request is made, instead of information of the above-described estimated time of arrival. In this case, the processor 31 predicts the estimated time of arrival of the driver who has made the pick-up request at the location based on the position information, the above-described traffic condition information, and location information included in the pick-up request information, and stores a prediction result in the database 32 as the pick-up information.

A table for each predetermined location (relay point) is stored in the database 32. An item of a time zone (for example, each time zone when 24 hours of one day is equally divided) is set in each table, and the above-described boarding information and pick-up information can be stored in association with each item.

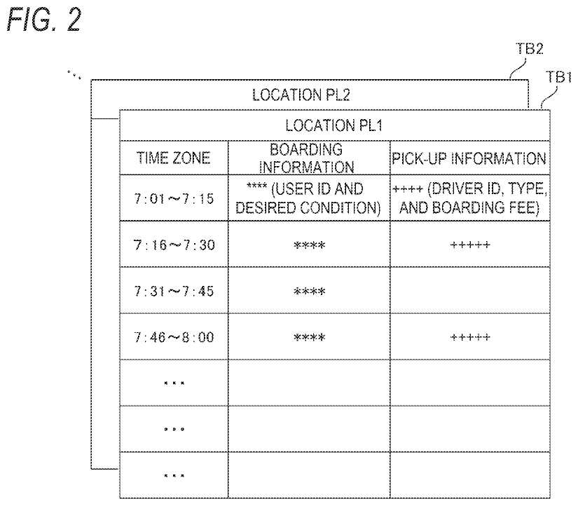

FIG. 2 is a schematic diagram showing an example of the table stored in a database 32. The database 32 includes a table for each of a plurality of locations. A table TB1 corresponds to the location PL1. A table TB2 corresponds to a location PL2 different from the location PL1. In each of the tables TB1, TB2, an item of a time zone obtained by dividing 24 hours of one day in units of 15 minutes is set.

When receiving the boarding request information, the processor 31 of the server 30 stores, as the boarding information, the desired condition and the user ID that are included in the boarding request information in the item of the time zone in the table corresponding to the location. The item of the time zone includes the estimated time of arrival included in the boarding request information. The table corresponding to the location is included in the boarding request information.

When receiving the pick-up request information, the processor 31 of the server 30 stores, as the pick-up information, the driver ID included in the pick-up request information, the type of the transportation vehicle registered in association with the driver ID by the driver registration, the number of people that can board, and the boarding fee in the item of the time zone in the table corresponding to the location. The item of the time zone includes the estimated time of arrival included in the pick-up request information. The table corresponding to the location is included in the pick-up request information.

When the time becomes a timing before predetermined time (for example, three minutes) in any time zone in each table of the database 32, the processor 31 of the server 30 acquires, from the user device 10, the position information of the user device 10 specified by each user ID in which the boarding information has been stored in each table at that timing. The processor 31 acquires, from the driver device 20, the position information of the driver device 20 specified by each driver ID in which the pick-up information has been stored in each table at that timing. Then, based on each piece of the acquired position information, the processor 31 specifies the user and the transportation vehicle that are present in a predetermined region (for example, a region having a radius of 1 km centered on the location PL1 (the location PL2) or a region where the location PL1 (the location PL2) can be reached within one minute) including the relay point, selects (that is, matches) the transportation vehicle optimal for the specified user from the specified transportation vehicles, and outputs a selection result.

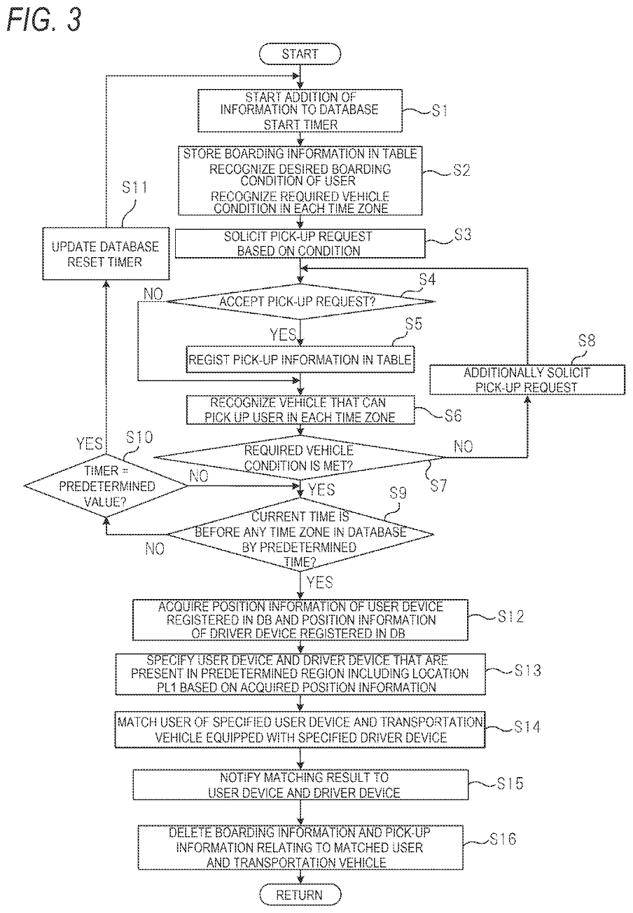

FIG. 3 is a flowchart showing operation of the processor 31. Hereinafter, in order to simplify the description, it is assumed that only the table TB1 is stored in the database 32.

When it is time to add the boarding information to the database 32, the processor 31 starts timing by a built-in timer, and further starts the addition of the boarding information to the database 32 based on the boarding request information received from the user device 10 until this timing (step Si).

First, the processor 31 stores the boarding information based on the boarding request information received from the user device 10 in the table TB1. Based on the boarding information stored in the table TB1, the processor 31 recognizes a desired boarding condition, of each user who desires to board, including an estimated time zone of boarding the transportation vehicle and a desired condition for the transportation vehicle at the location PL1. Further, the processor 31 recognizes a condition (hereinafter, described as a required vehicle condition) of the transportation vehicle required in each time zone at the location PL1 based on the recognized desired boarding condition of each user (step S2).

With reference to the boarding information in each time zone stored in the table TB1, the processor 31 can recognize the desired boarding condition, for example, which type of transportation vehicle each user desires to board in which time zone. Then, based on a recognition result, the processor 31 can recognize the required vehicle condition, for example, how many transportation vehicles of which type are required in each time zone.

Next, the processor 31 solicits the pick-up request from all the driver devices 20 registered in the system based on the required vehicle condition recognized in step S2 (step S3). Specifically, the processor 31 solicits the pick-up request by transmitting, to each of the driver devices 20, pick-up request solicitation information including the time zone, the desired condition of the user, and information for checking an intention of pick-up.

The driver who owns the driver device 20 that has received the pick-up request solicitation information operates the driver device 20 to make a pick-up request to the server 30 if the driver intends to pick up the user.

After step S3, the processor 31 determines whether the pick-up request, which is a response to the pick-up request solicitation information, has been accepted (step S4). When the pick-up request has been accepted (step S4: YES), the processor 31 stores, in the item of the time zone included in the received pick-up request information in the table TB1, the pick-up information including information of the driver ID of the driver who has made this pick-up request, the type of the transportation vehicle, and the boarding fee (step S5).

After step S5 or when the pick-up request is not accepted in step S4 (step S4: NO), the processor 31 recognizes how many transportation vehicles of which type can pick up the user in each time zone based on the pick-up information stored in the table TB1 (step S6).

Next, the processor 31 determines whether the number and type of the transportation vehicles that can pick up the user in each time zone recognized in step S6 meet the required vehicle condition in that time zone (step S7). When the time zone is present in which the required vehicle condition is not met (step S7: NO), the processor 31 additionally solicits the pick-up request for that time zone (step S8).

Specifically, the processor 31 transmits, to the driver device 20, the pick-up request solicitation information including the time zone in which the required vehicle condition is not satisfied, the type and the number of the transportation vehicles that are insufficient in that time zone, and the information for checking whether the driver intends to pick up the user.

After step S8, the processing returns to step S4. By performing the processing in step S8, a supply-demand balance between the user who desires to board in each time zone at a certain relay point and the transportation vehicle that can pick up the user at that relay point in that time zone is adjusted.

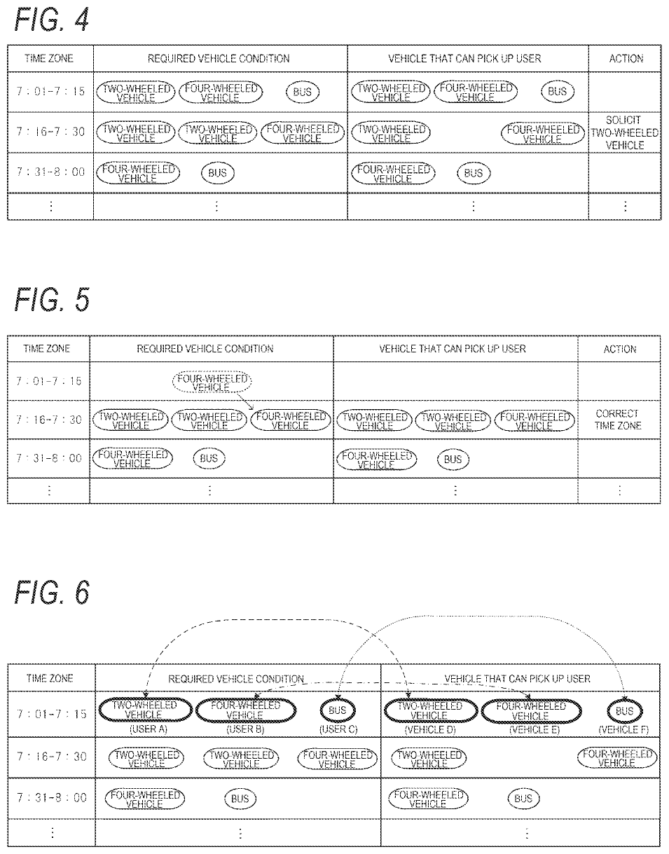

FIG. 4 schematically shows a recognition result of the processor 31 when determination in step S7 in FIG. 3 is executed. In an example in FIG. 4, in a time zone of 7:01 to 7:15, it is recognized that one two-wheeled vehicle, one four-wheeled vehicle, and one bus are required, and it is recognized that one two-wheeled vehicle, one four-wheeled vehicle, and one bus can pick up the user. In a time zone of 7:16 to 7:30, it is recognized that two two-wheeled vehicles and one four-wheeled vehicle are required, and it is recognized that one two-wheeled vehicle and one four-wheeled vehicle can pick up the user. In a time zone of 7:31 to 8:00, it is recognized that one four-wheeled vehicle and one bus are required, and it is recognized that one four-wheeled vehicle and one bus can pick up the user.

Therefore, in the example in FIG. 4, the processor 31 determines that the required vehicle condition is not satisfied in the time zone of 7:16 to 7:30, and additionally solicits one two-wheeled vehicle that is insufficient in this time zone.

As a result of the determination in step S7, if the required vehicle condition is met but a time zone is present in which the transportation vehicles are left over for the user who desires to board, the processor 31 may additionally solicit the boarding request for that time zone in step S8. In this way, it is possible to prevent the transportation vehicles scheduled to pick up the user from becoming excessive.

When the required vehicle condition is met in each time zone (step S7: YES), the processor 31 determines whether the current time is before the time zone in the table TB1 by any predetermined time (for example, three minutes or the like) (step S9). When the current time is not before the time zone by any predetermined time (step S9: NO), the processor 31 returns the processing to step S9 if the timed value of the built-in timer is less than a predetermined value (for example, 10 minutes), and executes the processing in step S11 if the timed value of the timer reaches the predetermined value.

In step S11, the processor 31 resets the timed value of the built-in timer to an initial value. Further, the processor 31 updates the information of the estimated time of arrival included in each of the boarding information and the pick-up information that are stored in the table TB1.

Specifically, the processor 31 acquires the position information of the user device 10 that is specified by the user ID included in the boarding information stored in the table TB1, and predicts the estimated time of arrival at which the user device 10 arrives at the location PL1 based on the position information, the traffic condition information acquired from the server, and the information of the location PL1. When the predicted estimated time of arrival is included in a time zone in which the boarding information is stored, the processor 31 maintains the boarding information as it is without updating the boarding information. When the predicted estimated time of arrival is not included in the time zone in which the boarding information is stored, the processor 31 changes a storage destination of the boarding information to a time zone including the predicted estimated time of arrival. The processor 31 performs this update processing on all the boarding information stored in the database 32.

Similarly, the processor 31 acquires the position information of the driver device 20 that is specified by the driver ID included in the pick-up information stored in the table TB1, and predicts the estimated time of arrival at which the driver device 20 arrives at the location PL1 based on the position information, the traffic condition information acquired from the server, and the information of the location PL1. When the predicted estimated time of arrival is included in a time zone in which the pick-up information is stored, the processor 31 maintains the pick-up information as it is without updating the pick-up information. When the predicted estimated time of arrival is not included in the time zone in which the pick-up information is stored, the processor 31 changes a storage destination of the pick-up information to a time zone including the predicted estimated time of arrival. The processor 31 performs this update processing on all the pick-up information stored in the database 32.

FIG. 5 is a schematic diagram showing processing in step S11 in FIG. 3. At a time point before the determination in step S10 is YES, it is recognized that one four-wheeled vehicle is required in the time zone of 7:01 to 7:15 as indicated by a dotted line. However, as a result of the prediction of the estimated time of arrival, when it is found that the user who desires to board the one four-wheeled vehicle arrives at the location PL1 in the time zone of 7:16 to 7:30, the storage destination of the boarding information relating to the user is changed to the time zone of 7:16 to 7:30. Accordingly, the required vehicle condition in the time zone of 7:16 to 7:30 is updated.

After the processing in step S11, the processing returns to step S1, and addition of the boarding information to the table TB1 is started based on the boarding request information newly transmitted from the user device 10 until step S1.

When the determination in step S9 is YES, the processor 31 acquires the position information of the user device 10 that is specified by the user ID included in each piece of the boarding information in the table TB1 from the user device 10, and acquires the position information of the driver device 20 that is specified by the driver ID included in each pick-up information in the table TB1 from the driver device 20 (step S12).

The processor 31 specifies the user (the user device 10) and the transportation vehicle (the driver device 20) that are present in a predetermined region including the location PL1 based on each piece of the position information acquired in step S12 (step S13).

The processor 31 matches the user of the user device 10 specified in step S13 and the transportation vehicle equipped with the driver device 20 specified in step S13 (step S14). A case in which the processing in step S14 is executed in a recognition state shown in FIG. 4 will be specifically described as an example.

FIG. 6 shows an example in which, at a timing before 7:01 by the predetermined time, a user A who desires to board the two-wheeled vehicle in the time zone of 7:01 to 7:15, a user B who desires to board the four-wheeled vehicle in the time zone of 7:01 to 7:15, and a user C who desires to board the bus in the time zone of 7:01 to 7:15 are present in the above-described predetermined region, and transportation vehicles D, E, F (a two-wheeled vehicle, a four-wheeled vehicle, and a bus) that can pick up the user in the time zone of 7:01 to 7:15 are present in the above-described predetermined region. In this case, the processor 31 matches the user and the transportation vehicle based on the boarding information including user IDs of the users A to C, the pick-up information including driver IDs of drivers of the transportation vehicles D, E, F, positions of the users A to C, and positions of the transportation vehicles D, E, F.

For example, for a user for whom the priority of the boarding fee is higher than the priority of the waiting time, the transportation vehicle is selected such that the boarding fee meets the desire even if the waiting time is long. For example, for a user for whom the priority of the waiting time is higher than the priority of the boarding fee, the transportation vehicle is selected such that the waiting time is the shortest according to the position information. For example, for a user for whom the priority of the type of the transportation vehicle is the highest, the transportation vehicle is selected to meet the desire even if the waiting time is long and the boarding fee is high. Alternatively, matching may be executed in a pattern in which the waiting time of both the user and the driver is short and the type of the transportation vehicle desired by the user is satisfied.

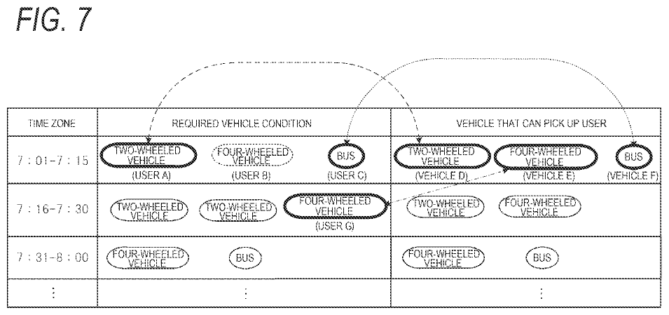

FIG. 7 shows an example in which, at the timing before 7:01 by the predetermined time, the user A who desires to board the two-wheeled vehicle in the time zone of 7:01 to 7:15, the user C who desires to board the bus in the time zone of 7:01 to 7:15, and a user G who desires to board the four-wheeled vehicle in the time zone of 7:16 to 7:30 are present in the above-described predetermined region, and the transportation vehicles D, E, F (the two-wheeled vehicle, the four-wheeled vehicle, and the bus) that can pick up the user in the time zone of 7:01 to 7:15 are present in the above-described predetermined region. In the case in FIG. 7, the user G desires to board in the time zone of 7:16 to 7:30, but approaches the above-described predetermined region earlier than expected. The user B desires to board the two-wheeled vehicle in the time zone of 7:01 to 7:15, but is not present in the predetermined region at the above-described timing due to a reason such as delayed arrival due to traffic congestion.

In this case, the processor 31 matches the user and the transportation vehicle in the same manner as described above based on the boarding information including user IDs of the user A, the user C, and the user G, the pick-up information including the driver IDs of the drivers of the transportation vehicles D, E, F, positions of the user A, the user C, and the user G, and the positions of the transportation vehicles D, E, F. According to this method, the matching is executed based on the position of the user and the position of the transportation vehicle at the timing before the predetermined time regardless of the desired time zone. Therefore, even when the time of arrival at the boarding location fluctuates, the waiting time of the user or the transportation vehicle can be reduced.

After step S14, the processor 31 notifies a matching result to the driver device 20 of the driver of the transportation vehicle matched to the user and the user device 10 of that user (step S15). Then, the processor 31 deletes the boarding information including the user ID of the user device 10 and the pick-up information including the driver ID of the driver device 20 from the database 32, and returns the processing to step S1.

As described above, at a time point when the boarding request is accepted, the service provision system 100 only adjusts (updates the database 32) supply and demand of the user and the transportation vehicle based on the boarding request. At a time point when the time zone of the table is approached, the service provision system 100 accepts the boarding request and the pick-up request at that time point, and matches the user and the transportation vehicle that are present in a vicinity of the relay point.

Therefore, if the user who desires to board in a certain time zone arrives at the relay point in the time zone as scheduled and the driver who desires to pick up the user in that time zone arrives at the relay point in that time zone as scheduled, matching is executed according to the desire of each other, and the waiting time of both the user and the driver can be shortened.

On the other hand, even when the user who desires to board in a certain time zone arrives at the relay point earlier than scheduled, if the driver who desires to pick up the user in a time zone immediately before the certain time zone arrives at the relay point in that time zone as scheduled, it is possible to match the transportation vehicle of the driver with the user who has arrived earlier. Therefore, even if the estimated time of arrival of at least one of the user and the driver fluctuates, the waiting time of both the user and the driver can be shortened. As described above, since the user and the transportation vehicle that desire to board and pick up the user in different time zones are matched with each other, the supply-demand balance may be temporarily lost. However, the supply-demand balance is adjusted by the subsequent processing in step S7 and step S8. Therefore, it is possible to continuously attain an effect of shortening the waiting time of both the user and the driver.

As described above, at least the following matters are described in the present specification.

(1) A service provision system in which a user device of a user who desires to board a vehicle at a predetermined location, a driver device of a driver who drives a vehicle that allows the user to board, and a control device are connected via a network,

in which the control device is configured to execute:
first processing of, based on information received from the user device, recognizing a desired boarding condition of a user owning the user device, the desired boarding condition including an estimated time zone of boarding a vehicle at the predetermined location;
second processing of recognizing a required vehicle condition at the predetermined location for a predetermined time zone based on the desired boarding condition;
third processing of recognizing a vehicle capable of picking up the user at the predetermined location in the predetermined time zone based on the required vehicle condition and information received from the driver device;
fourth processing of adjusting, based on the required vehicle condition and the vehicle capable of picking up the user, a supply-demand balance between the user who desires to board at the predetermined location in the predetermined time zone and the vehicle capable of picking up the user; and
fifth processing of, at a timing before the predetermined time zone is reached, specifying, based on position information of the user device and position information of the driver device of the driver of the vehicle capable of picking up the user, the user and the vehicle that are present in a predetermined region including the predetermined location from among the users and the vehicles capable of picking up the users that are recognized until the fourth processing, selecting an optimal vehicle for the specified user from among the specified vehicles, and outputting a selection result.

According to (1), it is possible to shorten the waiting time of both the user and the driver of the vehicle.

(2) A control device configured to match a user who desires to board a vehicle at a predetermined location with the vehicle, the control device including:

a processor,

in which the processor is configured to execute:
first processing of, based on information received from a user device of the user, recognizing a desired boarding condition of the user including an estimated time zone of boarding a vehicle at the predetermined location;
second processing of recognizing a required vehicle condition at the predetermined location for a predetermined time zone based on the desired boarding condition;
third processing of recognizing a vehicle capable of picking up the user at the predetermined location in the predetermined time zone based on the required vehicle condition and information received from a driver device of a driver who drives the vehicle;
fourth processing of adjusting, based on the required vehicle condition and the vehicle capable of picking up the user, a supply-demand balance between the user who desires to board at the predetermined location in the predetermined time zone and the vehicle capable of picking up the user; and
fifth processing of, at a timing before the predetermined time zone is reached, specifying, based on position information of the user device and position information of the driver device of the driver of the vehicle capable of picking up the user, the user and the vehicle that are present in a predetermined region including the predetermined location from among the users and the vehicles capable of picking up the users that are recognized until the fourth processing, selecting an optimal vehicle for the specified user from among the specified vehicles, and outputting a selection result.

According to (2), it is possible to shorten the waiting time of both the user and the driver of the vehicle.

(3) The control device according to (2),

in which the processor repeatedly executes, until the timing, the first processing, the second processing, the third processing, and the fourth processing.

According to (3), since the adjustment of the supply-demand balance is continued, an effect of shortening the waiting time of both the user and the driver of the vehicle can be maximized.

(4) The control device according to (3),

in which the processor recognizes, as the desired boarding condition, at least one of a type of a vehicle, waiting time until the user is capable of boarding a vehicle, and a fee required for boarding a vehicle, and

in which, in the fifth processing, an optimal vehicle is selected for the specified user based on the desired boarding condition.

According to (4), flexibility of matching the user and the vehicle can be improved.

(5) A matching method that is for matching a user who desires to board a vehicle at a predetermined location with the vehicle and that is executed by a processor, the matching method including:

first processing of, based on information received from a user device of the user, recognizing a desired boarding condition of the user including an estimated time zone of boarding a vehicle at the predetermined location;

second processing of recognizing a required vehicle condition at the predetermined location for a predetermined time zone based on the desired boarding condition;

third processing of recognizing a vehicle capable of picking up the user at the predetermined location in the predetermined time zone based on the required vehicle condition and information received from a driver device of a driver who drives the vehicle;

fourth processing of adjusting, based on the required vehicle condition and the vehicle capable of picking up the user, a supply-demand balance between the user who desires to board at the predetermined location in the predetermined time zone and the vehicle capable of picking up the user; and

fifth processing of, at a timing before the predetermined time zone is reached, specifying, based on position information of the user device and position information of the driver device of the driver of the vehicle capable of picking up the user, the user and the vehicle that are present in a predetermined region including the predetermined location from among the users and the vehicles capable of picking up the users that are recognized until the fourth processing, selecting an optimal vehicle for the specified user from among the specified vehicles, and outputting a selection result.

According to (5), it is possible to shorten the waiting time of both the user and the driver of the vehicle.

What is claimed is:

1. A service provision system in which a user device of a user who desires to board a vehicle at a predetermined location, a driver device of a driver who drives a vehicle that allows the user to board, and a control device are connected via a network,
wherein the control device is configured to execute:
first processing of, based on information received from the user device, recognizing a desired boarding condition of a user owning the user device, the desired boarding condition including an estimated time zone of boarding a vehicle at the predetermined location;
second processing of recognizing a required vehicle condition at the predetermined location for a predetermined time zone based on the desired boarding condition;
third processing of recognizing a vehicle capable of picking up the user at the predetermined location in the predetermined time zone based on the required vehicle condition and information received from the driver device;
fourth processing of adjusting, based on the required vehicle condition and the vehicle capable of picking up the user, a supply-demand balance between the user who desires to board at the predetermined location in the predetermined time zone and the vehicle capable of picking up the user; and
fifth processing of, at a timing before the predetermined time zone is reached, specifying, based on position information of the user device and position information of the driver device of the driver of the vehicle capable of picking up the user, the user and the vehicle that are present in a predetermined region including the predetermined location from among the users and the vehicles capable of picking up the users that are recognized until the fourth processing, selecting an optimal vehicle for the specified user from among the specified vehicles, and outputting a selection result.

2. A control device configured to match a user who desires to board a vehicle at a predetermined location with the vehicle, the control device comprising:
a processor,
wherein the processor is configured to execute:
first processing of, based on information received from a user device of the user, recognizing a desired boarding condition of the user including an estimated time zone of boarding a vehicle at the predetermined location;
second processing of recognizing a required vehicle condition at the predetermined location for a predetermined time zone based on the desired boarding condition;
third processing of recognizing a vehicle capable of picking up the user at the predetermined location in the predetermined time zone based on the required vehicle condition and information received from a driver device of a driver who drives the vehicle;
fourth processing of adjusting, based on the required vehicle condition and the vehicle capable of picking up the user, a supply-demand balance between the user who desires to board at the predetermined location in the predetermined time zone and the vehicle capable of picking up the user; and
fifth processing of, at a timing before the predetermined time zone is reached, specifying, based on position information of the user device and position information of the driver device of the driver of the vehicle capable of picking up the user, the user and the vehicle that are present in a predetermined region including the predetermined location from among the users and the vehicles capable of picking up the users that are recognized until the fourth processing, selecting an optimal vehicle for the specified user from among the specified vehicles, and outputting a selection result.

3. The control device according to claim 2,
wherein the processor repeatedly executes, until the timing, the first processing, the second processing, the third processing, and the fourth processing.

4. The control device according to claim 3,
wherein the processor recognizes, as the desired boarding condition, at least one of a type of a vehicle, waiting time until the user is capable of boarding a vehicle, and a fee required for boarding a vehicle, and
wherein, in the fifth processing, an optimal vehicle is selected for the specified user based on the desired boarding condition.

5. A matching method that is for matching a user who desires to board a vehicle at a predetermined location with the vehicle and that is executed by a processor, the matching method comprising:
first processing of, based on information received from a user device of the user, recognizing a desired boarding condition of the user including an estimated time zone of boarding a vehicle at the predetermined location;
second processing of recognizing a required vehicle condition at the predetermined location for a predetermined time zone based on the desired boarding condition;
third processing of recognizing a vehicle capable of picking up the user at the predetermined location in the predetermined time zone based on the required vehicle condition and information received from a driver device of a driver who drives the vehicle;
fourth processing of adjusting, based on the required vehicle condition and the vehicle capable of picking up the user, a supply-demand balance between the user who desires to board at the predetermined location in the predetermined time zone and the vehicle capable of picking up the user; and
fifth processing of, at a timing before the predetermined time zone is reached, specifying, based on position information of the user device and position information of the driver device of the driver of the vehicle capable of picking up the user, the user and the vehicle that are present in a predetermined region including the predetermined location from among the users and the vehicles capable of picking up the users that are recognized until the fourth processing, selecting an optimal vehicle for the specified user from among the specified vehicles, and outputting a selection result.
